(19) United States
(12) Patent Application Publication
(10) Pub. No.: US 2023/0297624 A1
(43) Pub. Date: Sep. 21, 2023

(54) SYSTEMS AND METHODS FOR CENTROID-BASED VECTOR ANALYSIS OF CONTENT ITEMS AND INTERACTIVE VISUAL REPRESENTATION GENERATION THEREOF

(71) Applicant: Sumitomo Pharma Co., Ltd., Osaka (JP)

(72) Inventors: Shigehiro ASANO, Osaka (JP); Yoann MAMY RANDRIAMIHAJA, Brooklyn, NY (US); Mingzhe TAO, Fairfax, VA (US)

(73) Assignee: Sumitomo Pharma Co., Ltd., Osaka (JP)

(21) Appl. No.: 18/120,962

(22) Filed: Mar. 13, 2023

Related U.S. Application Data
(60) Provisional application No. 63/320,133, filed on Mar. 15, 2022.
(60) Provisional application No. 63/449,851, filed on Mar. 3, 2023.

(51) Int. Cl. G06F 16/9038; G06F 16/9032

(52) U.S. Cl. CPC G06F 16/9038; G06F 16/90332

(57) ABSTRACT

A computer-implemented method, comprising the steps of analyzing a group of content items to determine a corresponding vector representation for each content item in the group of content items, the corresponding vector representation comprising a set of identifiers representing the corresponding content item in the group of content items; receiving, a search specification; identifying a relevant initial subset of content items in the group of content items; calculating a centroid vector; analyzing the corresponding vector representations of at least a portion of content items in the group of content items to determine relative relevancies of the at least the portion of content items in the group of content items; and providing an interactive graphical visualization of at least a segment of the relevant initial subset of content items in the group of content items and one or more other content items in the group of content items.

### CROSS-REFERENCE TO RELATED APPLICATIONS

The present application claims the benefit of U.S. Patent Application No. 63/320,133 for CENTROID VECTOR AND VECTOR REPRESENTATIONS OF CONTENT ITEMS, filed Mar. 15, 2022, and U.S. Patent Application No. 63/449,851 for SYSTEMS AND METHODS FOR CENTROID-BASED VECTOR analysis OF CONTENT ITEMS AND INTERACTIVE VISUAL REPRESENTATION GENERATION THEREOF, filed Mar. 3, 2023, the entire contents of which are incorporated herein by reference in their entirety.

### FIELD OF INVENTION

The present invention is in the field of biomedical information analysis, specifically graphical visual representation generation via vector analysis.

### INTRODUCTION

Data analysis is a process of converting information into a more useful form for supporting decision-making or drawing conclusions. Typical data analysis steps include collecting data, organizing data, manipulating data, and/or summarizing data. Oftentimes, data analysis is performed automatically by computer systems on datasets that are too large and complex for analysis by a human. In many scenarios, a goal of automated data analysis is to select a collection of data items that are substantially similar (e.g., in a specified and quantifiable sense) to one another and/or match other specified criteria. Accomplishing this goal can require determining accurate representations of data items that can be used to compare different data items. This can be challenging, particularly in the context of automated data analysis of large amounts of data. Thus, it would be beneficial to develop techniques directed toward characterization of data for robust and efficient comparison.

Typically, during a search of a database, a user expects the search to unearth the most relevant information from the database relative to the content of the search. However, conventional keyword searches may be deficient, in that such searches fail to uncover relevant search results when the relevant results do not contain the exact keyword search terms. Furthermore, analysis of traditional search results may be time consuming for a user, especially if there are many irrelevant results that are search keyword hits (e.g., if a search keyword is a common word or term).

Accordingly, it would be desirable to provide systems and methods configured to use improved search techniques to unearth relevant search results. It would be further desirable to provide systems and methods adapted to utilize centroid-based vector analysis to provide relevant search results. Yet further, it would be desirable to provide systems and methods configured to utilize such improved search results to generate interactive visual representations.

### SUMMARY

In accordance with the present disclosure, the following items are provided.

(Item 1). A computer-implemented method, comprising the steps of:
analyzing, via one or more server processors, a group of content items to determine a corresponding vector representation for each content item in the group of content items, the corresponding vector representation comprising a set of identifiers representing the corresponding content item in the group of content items;
receiving, via a server, a search specification;
identifying, via the server, based on the search specification, a relevant initial subset of content items in the group of content items;
calculating, via the one or more server processors, a centroid vector based on the corresponding vector representations of the content items in the relevant initial subset;
analyzing, via the one or more server processors, based on the centroid vector, the corresponding vector representations of at least a portion of content items in the group of content items to determine relative relevancies of the at least the portion of content items in the group of content items; and
providing, via a client device in informatic communication with the server, based on the determined relative relevancies, an interactive graphical visualization of one or more of the relevant initial subset of content items in the group of content items, of one or more other content items in the group of content items, or of a combination thereof.

(Item 2). The computer-implemented method of Item 1, wherein the search specification comprises text entered by a user or an item selected by the user from a taxonomy of topics.

(Item 3). The computer-implemented method of any one of Items 1 to 2, wherein the group of content items is a subset of content items from another source of content items.

(Item 4). The computer-implemented method of any one of Items 1 to 3, the step of identifying the relevant initial subset of content items in the group of content items based on the search specification further comprising automatically performing a keyword-based search to determine content items that match the keyword-based search.

(Item 5). The computer-implemented method of any one of Items 1 to 4, the step of identifying the relevant initial subset of content items in the group of content items based on the search specification further comprising receiving, from a user, a collection of content items related to the search specification to serve as the relevant initial subset of content items.

(Item 6). The computer-implemented method of any one of Items 1 to 5, the step of calculating the centroid vector based on the corresponding vector representations of the content items in the relevant initial subset further comprising determining a vector aggregation of the corresponding vector representations of the content items in the relevant initial subset.

(Item 7.) The computer-implemented method of any one of Items 1 to 6, the step of analyzing the corresponding vector representations of at least the portion of content items in the group of content items to determine relative relevancies of at least the portion of content items in the group of content items further comprising computing a vector comparison metric to the centroid vector, wherein the vector comparison metric is a distance metric.

(Item 8). The computer-implemented method of any one of Items 1 to 3 and 5 to 7, wherein the one or more other content items in the group of content items comprise content items that do not match a keyword-based search associated with the search specification.

(Item 9). The computer-implemented method of any one of Items 1 to 8, wherein the interactive graphical visualization comprises a multidimensional visualization of at least the segment of the relevant initial subset of content items in the group of content items and the one or more other content items in the group of content items.

(Item 10). The computer-implemented method of any one of Items 1 to 9, wherein the interactive graphical visualization comprises display items that include relative spacings between one another that map to the relative relevancies between content items that correspond to the display items.

(Item 11). The computer-implemented method of any one of Items 1 to 9, wherein the interactive graphical visualization comprises display items that include relative spacings between one another that are based on distances between vector representations that correspond to the display items.

(Item 12). The computer-implemented method of any one of Items 1 to 11, wherein the interactive graphical visualization comprises axes that correspond to retained components of a vector projection technique.

(Item 13). The computer-implemented method of any one of Items 1 to 3, 5 to 7, and 9 to 12, wherein the interactive graphical visualization comprises an identification of the centroid vector and a specified number of nearest neighbors to the centroid vector, and wherein the specified number of nearest neighbors comprises two categories of nearest neighbors that are visually distinguished from each other, wherein a first category of nearest neighbors corresponds to matches of a keyword-based search for the search specification and a second category of nearest neighbors corresponds to content items derived via a vector-based search.

(Item 14). The computer-implemented method of any one of Items 1 to 13, wherein the interactive graphical visualization comprises a display of multiple centroid vectors corresponding to different vector space mappings.

(Item 15). The computer-implemented method of any one of Items 1 to 14, further comprising the step of updating the interactive graphical visualization to display a new centroid that corresponds to a content item selected by a user.

(Item 16). The computer-implemented method of any one of Items 1 to 15, further comprising the steps of receiving a user selection of a content item; and providing summary information for the content item of the user selection.

(Item 17). The computer-implemented method of any one of Items 1 to 16, further comprising the step of receiving, from a user, a specification of a content item to include or exclude from the group of content items or to weight differently for centroid vector calculation.

(Item 18). The computer-implemented method of any one of Items 1 to 17, further comprising the steps of receiving a user interaction associated with the centroid vector; and providing a list of content items associated with calculating the centroid vector.

(Item 19). A system, comprising:
a server in bidirectional communication with a client device, the server comprising at least one server processor, at least one server database, at least one server memory comprising computer-executable server instructions which, when executed by the at least one server processor, cause the server to:
analyze, via one or more server processors, a group of content items to determine a corresponding vector representation for each content item in the group of content items, the corresponding vector representation comprising a set of identifiers representing the corresponding content item in the group of content items;
receive, via a server, a search specification;
identify, via the server, based on the search specification, a relevant initial subset of content items in the group of content items;
calculate, via the one or more server processors, a centroid vector based on the corresponding vector representations of the content items in the relevant initial subset;
analyze, via the one or more server processors, based on the centroid vector, the corresponding vector representations of at least a portion of content items in the group of content items to determine relative relevancies of the at least the portion of content items in the group of content items; and
provide based on the determined relative relevancies, an interactive graphical visualization of one or more of the relevant initial subset of content items in the group of content items, of one or more other content items in the group of content items, or of a combination thereof; and
a client device comprising at least one device processor, at least one display, at least one device memory comprising computer-executable device instructions which, when executed by the at least one device processor, cause the client device to:
display the interactive graphical visualization.

(Item 20). The system of Item 19, wherein the search specification comprises text entered by a user or an item selected by the user from a taxonomy of topics.

(Item 21). The system of any one of Items 19 to 20, wherein the group of content items is a subset of content items from another source of content items.

(Item 22). The system of any one of Items 19 to 21, wherein the computer-executable server instructions which, when executed by the at least one server processor, cause the server to identify the relevant initial subset of content items in the group of content items based on the search specification further causes the server to automatically perform a keyword-based search to determine content items that match the keyword-based search.

(Item 23). The system of any one of Items 19 to 22, wherein the computer-executable server instructions which, when executed by the at least one server processor, cause the server to identify the relevant initial subset of content items in the group of content items based on the search specification further causes the server to receive, from a user, a collection of content items related to the search specification to serve as the relevant initial subset of content items.

(Item 24). The system of any one of Items 19 to 23, wherein the computer-executable server instructions which, when executed by the at least one server processor, cause the server to calculate the centroid vector based on the corresponding vector representations of the content items in the relevant initial subset further cause the server to determine a vector aggregation of the corresponding vector representations of the content items in the relevant initial subset.

(Item 25). The system of any one of Items 19 to 24, wherein the computer-executable server instructions which, when executed by the at least one server processor, cause the server to analyze the corresponding vector representations of at least the portion of content items in the group of content items to determine relative relevancies of at least the portion of content items in the group of content items further cause the server to compute a vector comparison metric to the centroid vector, wherein the vector comparison metric is a distance metric.

(Item 26). The system of any one of Items 19 to 21 and 23 to 25, wherein the one or more other content items in the group of content items comprise content items that do not match a keyword-based search associated with the search specification.

(Item 27). The system of any one of Items 19 to 26, wherein the interactive graphical visualization comprises a multidimensional visualization of at least the segment of the relevant initial subset of content items in the group of content items and the one or more other content items in the group of content items.

(Item 28). The system of any one of Items 19 to 27, wherein the interactive graphical visualization comprises display items that include relative spacings between one another that map to the relative relevancies between content items that correspond to the display items.

(Item 29). The system of any one of Items 19 to 27, wherein the interactive graphical visualization comprises display items that include relative spacings between one another that are based on distances between vector representations that correspond to the display items.

(Item 30). The system of any one of Items 19 to 29, wherein the interactive graphical visualization comprises axes that correspond to retained components of a vector projection technique.

(Item 31). The system of any one of Items 19 to 21, 23 to 25, and 27 to 30, wherein the interactive graphical visualization comprises an identification of the centroid vector and a specified number of nearest neighbors to the centroid vector, and wherein the specified number of nearest neighbors comprises two categories of nearest neighbors that are visually distinguished from each other, wherein a first category of nearest neighbors corresponds to matches of a keyword-based search for the search specification and a second category of nearest neighbors corresponds to content items derived via a vector-based search.

(Item 32). The system of any one of Items 19 to 31, wherein the interactive graphical visualization comprises a display of multiple centroid vectors corresponding to different vector space mappings.

(Item 33). The system of any one of Items 19 to 32, the computer-executable server instructions which, when executed by the at least one server processor, cause the server to update the interactive graphical visualization to display a new centroid that corresponds to a content item selected by a user.

(Item 34). The system of any one of Items 19 to 33, the computer-executable server instructions which, when executed by the at least one server processor, cause the server to receive a user selection of a content item; and provide summary information for the content item of the user selection.

(Item 35). The system of any one of Items 19 to 34, the computer-executable server instructions which, when executed by the at least one server processor, cause the server to receive, from a user, a specification of a content item to include or exclude from the group of content items or to weight differently for centroid vector calculation.

(Item 36). The system of any one of Items 19 to 35, the computer-executable server instructions which, when executed by the at least one server processor, cause the server to receive a user interaction associated with the centroid vector; and provide a list of content items associated with calculating the centroid vector.

(Item 37). A non-transitory computer readable medium having a set of instructions stored thereon that, when executed by a processing device, cause the processing device to carry out an operation of clinical result aggregation, the operation comprising:
analyzing, via one or more server processors, a group of content items to determine a corresponding vector representation for each content item in the group of content items, the corresponding vector representation comprising a set of identifiers representing the corresponding content item in the group of content items;
receiving, via a server, a search specification;
identifying, via the server, based on the search specification, a relevant initial subset of content items in the group of content items;
calculating, via the one or more server processors, a centroid vector based on the corresponding vector representations of the content items in the relevant initial subset;
analyzing, via the one or more server processors, based on the centroid vector, the corresponding vector representations of at least a portion of content items in the group of content items to determine relative relevancies of the at least the portion of content items in the group of content items; and
providing, via a client device in informatic communication with the server, based on the determined relative relevancies, an interactive graphical visualization of one or more of the relevant initial subset of content items in the group of content items, of one or more other content items in the group of content items, or of a combination thereof.

(Item 38). The non-transitory computer readable medium of Item 37, wherein the search specification comprises text entered by a user or an item selected by the user from a taxonomy of topics.

(Item 39). The non-transitory computer readable medium of any one of Items 37 to 38, wherein the group of content items is a subset of content items from another source of content items.

(Item 40). The non-transitory computer readable medium of any one of Items 37 to 39, identifying the relevant initial subset of content items in the group of content items based on the search specification further comprising automatically performing a keyword-based search to determine content items that match the keyword-based search.

(Item 41). The non-transitory computer readable medium of any one of Items 37 to 40, identifying the relevant initial subset of content items in the group of content items based on the search specification further comprising receiving, from a user, a collection of content items related to the search specification to serve as the relevant initial subset of content items.

(Item 42). The non-transitory computer readable medium of any one of Items 37 to 41, calculating the centroid vector based on the corresponding vector representations of the content items in the relevant initial subset further comprising determining a vector aggregation of the corresponding vector representations of the content items in the relevant initial subset.

(Item 43). The non-transitory computer readable medium of any one of Items 37 to 42, analyzing the corresponding vector representations of at least the portion of content items in the group of content items to determine relative relevancies of at least the portion of content items in the group of content items further comprising computing a vector comparison metric to the centroid vector, wherein the vector comparison metric is a distance metric.

(Item 44). The non-transitory computer readable medium of any one of Items 37 to 39 and 41 to 43, wherein the one or more other content items in the group of content items comprise content items that do not match a keyword-based search associated with the search specification.

(Item 45). The non-transitory computer readable medium of any one of Items 37 to 44, wherein the interactive graphical visualization comprises a multidimensional visualization of at least the segment of the relevant initial subset of content items in the group of content items and the one or more other content items in the group of content items.

(Item 46). The non-transitory computer readable medium of any one of Items 37 to 45, wherein the interactive graphical visualization comprises display items that include relative spacings between one another that map to the relative relevancies between content items that correspond to the display items.

(Item 47). The non-transitory computer readable medium of any one of Items 37 to 45, wherein the interactive graphical visualization comprises display items that include relative spacings between one another that are based on distances between vector representations that correspond to the display items.

(Item 48). The non-transitory computer readable medium of any one of Items 37 to 47, wherein the interactive graphical visualization comprises axes that correspond to retained components of a vector projection technique.

(Item 49). The non-transitory computer readable medium of any one of Items 37 to 39, 41 to 43, and 45 to 48, wherein the interactive graphical visualization comprises an identification of the centroid vector and a specified number of nearest neighbors to the centroid vector, and wherein the specified number of nearest neighbors comprises two categories of nearest neighbors that are visually distinguished from each other, wherein a first category of nearest neighbors corresponds to matches of a keyword-based search for the search specification and a second category of nearest neighbors corresponds to content items derived via a vector-based search.

(Item 50). The non-transitory computer readable medium of any one of Items 37 to 49, wherein the interactive graphical visualization comprises a display of multiple centroid vectors corresponding to different vector space mappings.

(Item 51). The non-transitory computer readable medium of any one of Items 37 to 50, the operation further comprising updating the interactive graphical visualization to display a new centroid that corresponds to a content item selected by a user.

(Item 52). The non-transitory computer readable medium of any one of Items 37 to 51, further comprising the steps of receiving a user selection of a content item; and providing summary information for the content item of the user selection.

(Item 53). The non-transitory computer readable medium of any one of Items 37 to 52, the operation further comprising receiving, from a user, a specification of a content item to include or exclude from the group of content items or to weight differently for centroid vector calculation.

(Item 54). The non-transitory computer readable medium of any one of Items 37 to 53, the operation further comprising receiving a user interaction associated with the centroid vector; and providing a list of content items associated with calculating the centroid vector.

(Item 55). A computer-implemented method, comprising the steps of:
analyzing, via one or more server processors, a group of content items to determine a corresponding vector representation for each content item in the group of content items, the corresponding vector representation comprising a set of identifiers representing the corresponding content item in the group of content items,
wherein the group of content items is a subset of content items from another source of content items;
receiving, via a server, a search specification,
wherein the search specification comprises text entered by a user or an item selected by the user from a taxonomy of topics;
identifying, via the server, based on the search specification, a relevant initial subset of content items in the group of content items by automatically performing a keyword-based search to determine content items that match the keyword-based search;
calculating, via the one or more server processors, a centroid vector based on the corresponding vector representations of the content items in the relevant initial subset;
analyzing, via the one or more server processors, based on the centroid vector, the corresponding vector representations of at least a portion of content items in the group of content items to determine relative relevancies of the at least the portion of content items in the group of content items; and
providing, via a client device in informatic communication with the server, based on the determined relative relevancies, an interactive graphical visualization of one or more of the relevant initial subset of content items in the group of content items, of one or more other content items in the group of content items, or of a combination thereof.

(Item 56). A system, comprising:
a server in bidirectional communication with a client device, the server comprising at least one server processor, at least one server database, at least one server memory comprising computer-executable server instructions which, when executed by the at least one server processor, cause the server to:
analyze, via one or more server processors, a group of content items to determine a corresponding vector representation for each content item in the group of content items, the corresponding vector representation comprising a set of identifiers representing the corresponding content item in the group of content items;
receive, via a server, a search specification;
identify, via the server, based on the search specification, a relevant initial subset of content items in the group of content items;
calculate, via the one or more server processors, a centroid vector based on the corresponding vector representations of the content items in the relevant initial subset;
analyze, via the one or more server processors, based on the centroid vector, the corresponding vector representations of at least a portion of content items in the group of content items to determine relative relevancies of the at least the portion of content items in the group of content items
compute, via the one or more server processors, a vector comparison metric to the centroid vector, wherein the vector comparison metric is a distance metric; and
provide based on the determined relative relevancies, an interactive graphical visualization of one or more of the relevant initial subset of content items in the group of content items, of one or more other content items in the group of content items, or of a combination thereof,
wherein the interactive graphical visualization comprises a multidimensional visualization of at least the segment of the relevant initial subset of content items in the group of content items and the one or more other content items in the group of content items,
wherein the interactive graphical visualization comprises display items that include relative spacings between one another that are based on distances between vector representations that correspond to the display items,
wherein the interactive graphical visualization comprises an identification of the centroid vector and a specified number of nearest neighbors to the centroid vector,
wherein the specified number of nearest neighbors comprises two categories of nearest neighbors that are visually distinguished from each other, wherein a first category of nearest neighbors corresponds to matches of a keyword-based search for the search specification and a second category of nearest neighbors corresponds to content items derived via a vector-based search; and
a client device comprising at least one device processor, at least one display, at least one device memory comprising computer-executable device instructions which, when executed by the at least one device processor, cause the client device to:
display the interactive graphical visualization.

(Item 57). A non-transitory computer readable medium having a set of instructions stored thereon that, when executed by a processing device, cause the processing device to carry out an operation of clinical result aggregation, the operation comprising:
analyzing, via one or more server processors, a group of content items to determine a corresponding vector representation for each content item in the group of content items, the corresponding vector representation comprising a set of identifiers representing the corresponding content item in the group of content items;
receiving, via a server, a search specification;
receiving, via a client device, a collection of content items related to the search specification;
identifying, via the server, based on the collection of content items related to the search specification, a relevant initial subset of content items in the group of content items;
calculating, via the one or more server processors, a centroid vector based on the corresponding vector representations of the content items in the relevant initial subset;
analyzing, via the one or more server processors, based on the centroid vector, the corresponding vector representations of at least a portion of content items in the group of content items to determine relative relevancies of the at least the portion of content items in the group of content items;
providing, via the client device in informatic communication with the server, based on the determined relative relevancies, an interactive graphical visualization of one or more of the relevant initial subset of content items in the group of content items, of one or more other content items in the group of content items, or of a combination thereof,
wherein the one or more other content items in the group of content items comprise content items that do not match a keyword-based search associated with the search specification;
receiving, via the client device, a user selection of a content item;
providing, via the client device, summary information for the content item of the user selection; and
receiving, via the client device, a specification of a content item to include or exclude from the group of content items or to weight differently for centroid vector calculation.

(Item 58). A computer-implemented method, comprising the steps of:
analyzing, via one or more server processors, a group of content items to determine a corresponding vector representation for each content item in the group of content items; receiving, via a server, a search specification;
identifying, via the server, a relevant initial subset of content items in the group of content items; calculating, via the one or more server processors, a centroid vector based on the corresponding vector representations of the content items in the relevant initial subset;
analyzing, via the one or more server processors, the corresponding vector representations of at least a portion of content items in the group of content items to determine relative relevancies of the at least the portion of content items in the group of content items; and
providing, based on the determined relative relevancies, an interactive graphical visualization of one or more of the relevant initial subset of content items in the group of content items, of one or more other content items in the group of content items, or of a combination thereof.

Additional aspects related to this disclosure are set forth, in part, in the description which follows, and, in part, will be obvious from the description, or may be learned by practice of this disclosure.

It is to be understood that both the forgoing and the following descriptions are exemplary and explanatory only and are not intended to limit the claimed disclosure or application thereof in any manner whatsoever.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 is a block diagram illustrating an embodiment of a system for determining and displaying related content items based on their vector representations.

FIG. 2 is a diagram illustrating an intersection of keyword-based search and vector-based search results.

FIG. 3A is a diagram illustrating user interface elements of a system for determining and displaying related content items based on their vector representations.

FIG. 3B is a diagram illustrating a visualization of related content items.

FIG. 4 is a flow diagram illustrating an embodiment of a process for determining and displaying related content items based on their vector representations.

FIG. 5 is a flow diagram illustrating an embodiment of a process for identifying a relevant initial subset of content items.

FIG. 6 is a flow diagram illustrating an embodiment of a process for determining relative relevancies of content items.

FIG. 7 is a flow diagram illustrating an embodiment of a process for modifying a centroid.

FIG. 8 is a functional diagram illustrating a programmed computer system that can implement one or more aspects of an embodiment of the invention.

FIG. 9 illustrates a block diagram of a distributed computer system that can implement one or more aspects of an embodiment of the present invention.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

The present disclosure relates to systems and methods for determining and displaying related content items based on their vector representations

In an embodiment, a group (e.g., library) of content items is analyzed to determine a corresponding vector representation for each content item in the group of content items, wherein the corresponding vector representation includes a set of identifiers representing the corresponding content item in the group of content items. In such an embodiment, a search specification is received. A relevant initial subset of content items in the group of content items may be identified based on the search specification. Yet further, a centroid vector may be calculated based on the corresponding vector representations of the content items in the relevant initial subset. Based on the centroid vector, the corresponding vector representations of at least a portion of content items in the group of content items may be analyzed to determine relative relevancies of at least the portion of content items in the group of content items. Accordingly, the determined relative relevancies may be used to provide an interactive graphical visualization of at least a portion of the relevant initial subset of content items in the group of content items and one or more other content items in the group of content items.

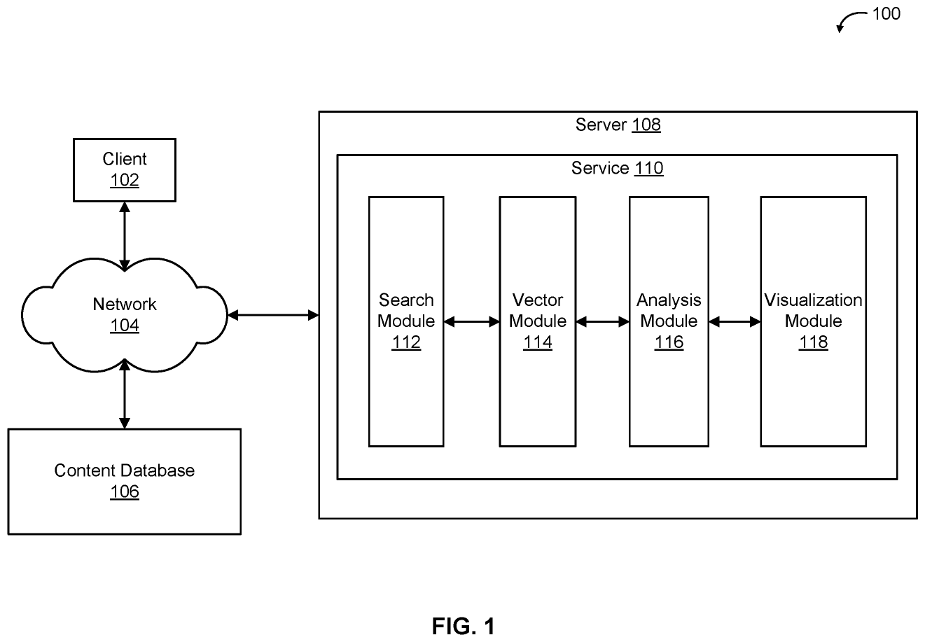

FIG. 1 is a block diagram illustrating an embodiment of a system for determining and displaying related content items based on their vector representations. In the example shown, system 100 includes client 102, network 104, content database 106, and/or server 108. Server 108, as shown in FIG. 1, may include service 110. Service 110 may comprise a search module 112, a vector module 114, an analysis module 116, and/or a visualization module 118. The number of components and the connections shown in FIG. 1 are merely illustrative. Therefore, other system architectures that implement the techniques disclosed herein are also possible.

In various embodiments, client 102 is a computer or other hardware device that a user utilizes to submit queries and receive and/or view responses. As non-limiting examples, client hardware devices include desktop computers, laptop computers, tablets, smartphones, virtual reality (VR) headsets, augmented reality (AR) glasses, and other devices. In various embodiments, the client hardware device includes a software user interface through which the user can submit search queries and receive and/or view responses. For example, the software user interface may be a web portal, internal network portal, or other portal that allows the user to submit text search queries and graphically view and interact with received search results. Other examples of software from which search queries may originate include browsers, mobile apps, chat clients, and the like.

As shown in FIG. 1, client 102, content database 106, and server 108 are communicatively connected via network 104. Search queries may be transmitted to, and responses received from, server 108 via network 104. Examples of network 104 include one or more of the following: a direct or indirect physical communication connection, mobile communication network, Internet, intranet, Local Area Network, Wide Area Network, Storage Area Network, and any other form of connecting two or more systems, components, or storage devices jointly.

In an embodiment, content database 106 is configured to store digital content items that are retrieved by service 110 of server 108. Digital content items may include, but are not limited to, text-based documents (e.g., scientific articles or publications, press releases, news articles, books, websites converted into documents, and any other types of documents), images, audio files, video files, tabular files, slide presentation files, medical health records, laboratory tests, genomic data, digital representations of people, and any other types of content items that can be represented digitally. In some embodiments, content database 106 spans multiple data sources (e.g., multiple Internet sources providing documents). In various embodiments, content database 106 is a structured set of data held in one or more computers and/or storage devices. Examples of storage devices include hard disk drives and solid-state drives.

In various embodiments, server 108 is a computer or other hardware component that provides content item search and visualization functionality. In the example illustrated, service 110 resides on server 108. In various embodiments, service 110 is a computer software element with various modules that are software sub-components. In some embodiments, search module 112, vector module 114, analysis module 116, and visualization module 118 comprise these software sub-components.

In various embodiments, search module 112 is configured to locate information in various computer resources. In an embodiment, search module 112 is adapted to locate documents (e.g., scientific articles) relevant to a search query. In various embodiments, the information that search module 112 locates resides in a storage system (e.g., content database 106) that is separate from server 108. Alternatively, the information may be located on server 108. For purposes of illustrative clarity, the example of searching for biomedical research papers (also referred to as articles, scientific articles, publications, scientific publications, papers, scientific papers, etc.) is presented herein. This example is merely illustrative and not restrictive. The techniques disclosed herein can be applied to various other use cases (e.g., searching for different types of documents and/or types of content items).

In such a non-limiting example, a common user goal is to search for publications that are related to a topic and to surface such publications even if they do not explicitly include search terms used in a keyword search. The example of sinus pause is presented throughout herein as an example of a search. Sinus pause (also called sinoatrial pause) refers to a medical condition in which there is a pause of the heart's sinoatrial node for a specified amount of time (commonly defined as less than two or three seconds). Sinus pause is considered to be at least in part a nervous system condition because of the role the nervous system plays in controlling the sinoatrial node. The example of sinus pause is merely illustrative and not restrictive. In many scenarios, a user is able to search a large online database (e.g., a biomedical publication database such as PubMed® for the topic of sinus pause) using a keyword-based search. However, a keyword-based search has several limitations. For example, a keyword-based search may fail to uncover many relevant results that do not explicitly include the search keywords. Furthermore, analysis of traditional search results may be time consuming for a user, especially if there are many irrelevant results that are search keyword hits (e.g., if a search keyword is a common word or term).

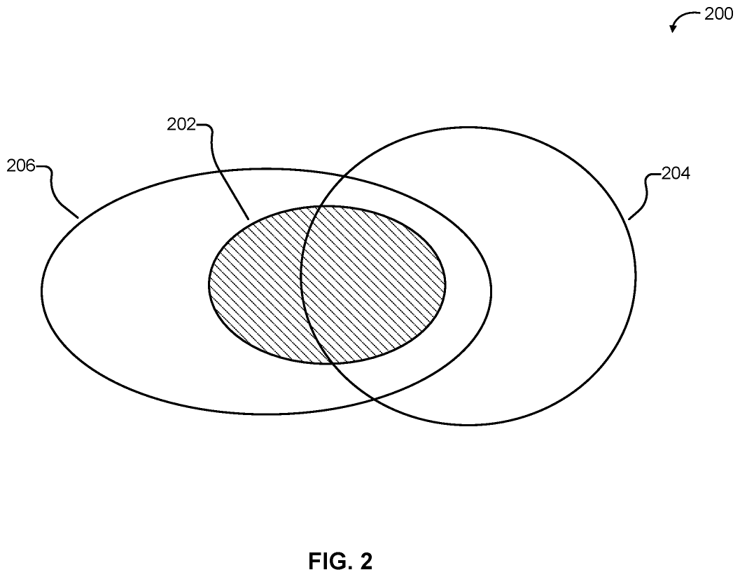

To overcome the limitations of keyword-based search and improve computer search technology, the techniques disclosed herein describe (among other aspects that are illustrated in further detail herein) the addition of a vector-based search approach to complement a keyword-based search. This approach has the practical and technological benefit of providing a more comprehensive and useful list of results for a computer search topic of interest (e.g., sinus pause). FIG. 2 diagrammatically illustrates the relationship between keyword-based search and vector-based search and highlights the limitations of solely using keyword-based search. Region 202 of FIG. 2 represents highly relevant content items of interest to a user (e.g., highly relevant papers concerning sinus pause). Region 204 of FIG. 2 represents content items surfaced by keyword-based search. As shown in FIG. 2, region 204 only partially overlaps with region 202, indicating that keyword-based search misses some highly relevant content items (due to a number of highly relevant content items not containing keyword search terms). Similarly, region 204 also includes a portion that does not overlap with region 202, which indicates that keyword-based search also surfaces content items that are not highly relevant. Region 206 of FIG. 2 represents content items surfaced by vector-based search. As shown in FIG. 2, region 206 includes the highly relevant content items of region 202 that keyword-based search misses (due to vector-based search not being limited to only finding content items with keyword search terms). Thus, a benefit of vector-based search is improved completeness. Stated alternatively, search recall is improved. As described in further detail herein, in various embodiments, keyword-based search is utilized in conjunction with vector-based search (e.g., for centroid vector calculation). Centroid vector calculation is described in further detail below. Another limitation of keyword-based search is that keyword-based search does not necessarily compare content items quantitatively; thus, search results can be difficult to rank. In a vector-based approach, as described in further detail herein, content items are vectorized and can be compared quantitatively, which facilitates ranking of search results.

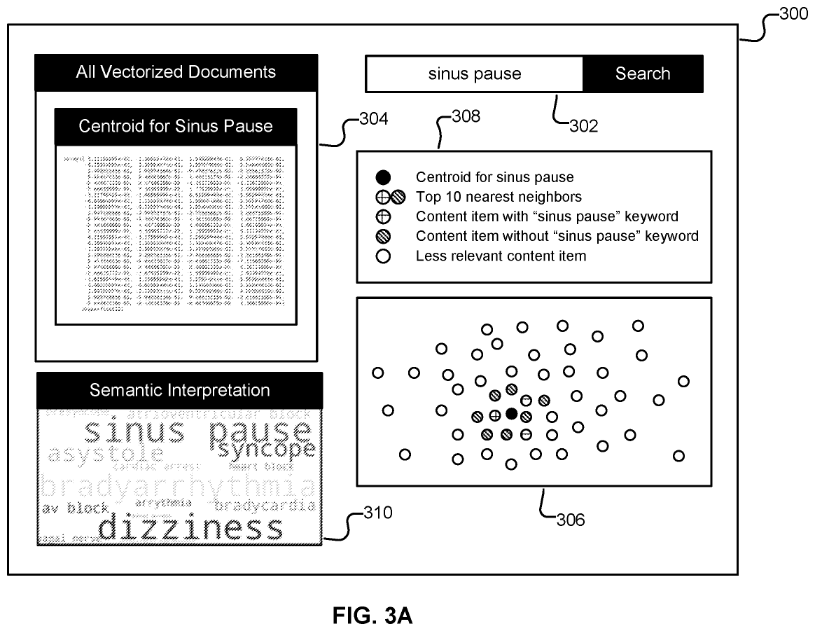

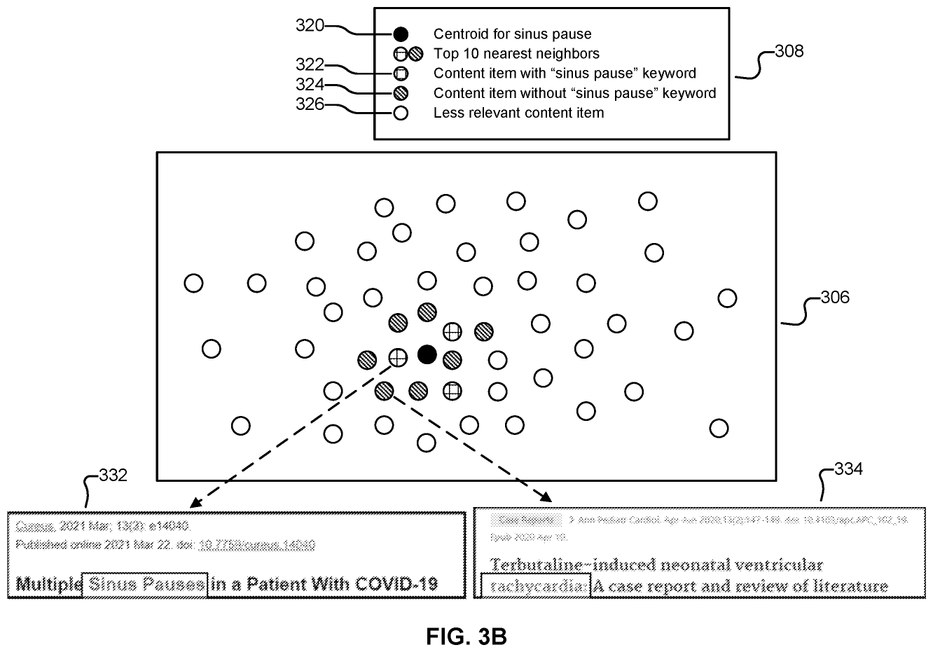

Returning to FIG. 1, in various embodiments, search module 112 receives a search specification from a user (e.g., from client 102). For example, the search specification may include the term “sinus pause”. This is shown as search element 302 of FIG. 3A, which illustrates a search bar in which the term “sinus pause” is entered. FIG. 3A shows an example of various user interface elements associated with the techniques disclosed herein. Display 300 of FIG. 3A specifically illustrates the sinus pause example. In various embodiments, service 110 defines a universe of content items to be searched to match the search specification. Stated alternatively, a selection of a corpus of content items (e.g., documents) may be performed based on a search input (e.g., the “sinus pause” search term). The corpus of content items may also be referred to as a library of content items. In some embodiments, selecting the corpus of content items includes restricting the universe of content items to be searched based on the search input. For example, with respect to the sinus pause example, the article search space of PubMed® (and/or another content database) may be limited to a specific disease area (e.g., autoimmune diseases for the example of sinus pause). Stated alternatively, it is possible to reduce the scope of documents to a specific group of medical subject headings that are mapped to a keyword topic. Limiting the corpus of content items can be important for computational efficiency reasons (e.g., reduces search time). In some embodiments, the keyword topic is mapped to a search space based on an ontology and/or taxonomy. In a further embodiment, the system may be configured to receive, from a user, a taxonomy of topics or a selection of one or more topics from the taxonomy of topics. In such an embodiment, the search specification may include the user's taxonomy topic selection(s). For example, medical conditions (e.g., sinus pause) can be classified according to standardized ontologies and/or taxonomies, which may enable that search spaces for medical conditions can be mapped in predictable ways. A collection of content items in the corpus of content items may be handled by search module 112. As a non-limiting example, search module 112 may coordinate retrieval of content items from content database 106 via network 104. In some embodiments, the universe of content items to be searched is comprised of different types of content items (e.g., press releases in addition to scientific articles). In such embodiments, multiple corpus types may be combined (e.g., combining a corpus of scientific articles from a database such as PubMed® with a corpus of press releases from another online database). The user may also have the option to manually add and/or exclude content items (e.g., documents) from the universe of content items to be searched. As a non-limiting example, a collection of content items related to the search specification may be submitted to the search module 112 (or other suitable component) to serve as part of, or the entirety of, the relevant initial subset of content items. In such a non-limiting example, a user may upload or otherwise indicate a collection of items that the user believes will be relevant to the search. The search module 112 may be configured to receive such a collection of items via display 300 or components thereof. In an aspect, at 502 or 504, the system may restrict keyword-based searches, or restrict the content items to be searched, as a function of the collection of items described above.

In various embodiments, all content items in the corpus of content items (e.g., retrieved by search module 112) are vectorized by vector module 114. As used herein, vectorization (generating vector representations) refers to mapping a content item to a numerical representation comprising an array of values. Vectorization has the benefit of reducing the data size of a content item. Vectorization provides a quantitative format by which different content items can be compared to one another. In some embodiments, content items in content database 106 are analyzed and corresponding vector representations are generated as the content items are added to content database 106. Stated alternatively, in some embodiments, vector module 114 has already generated vector representations of at least a portion of the content items of content database 106 at the time that the search specification is received by search module 112. In such embodiments, vector module 114 is only required to access already generated vector representations for a specified corpus of content items. Consequently, this can reduce computation time for service 110. It is also possible, in alternative embodiments, for vector module 114 to generate vector representations of content items in the corpus in real time after the search specification is received. Another possible adjustment to improve computation time is to vectorize a portion of a content item. For example, with respect to the sinus pause example, it is possible to vectorize abstracts of scientific articles instead of entire scientific articles to reduce computation time.

In various embodiments, each generated vector representation for each content item in the corpus of content items comprises a set of dimensions representing the corresponding content item in the corpus. The set of dimensions may include numerical values that may serve as coordinates in a multi-dimensional vector space (i.e., the dimensionality being N, wherein N is the number of dimensions). For example, with respect to the sinus pause example, a scientific article may be converted into a vector with 100 entries, making the corresponding vector space 100-dimensional. A benefit of vectorization is that content items of different sizes (e.g., documents of varying lengths) can all be converted to a same-sized vector representation, which may allow comparison of content items because the corresponding vector representations may share a common format.

Various vectorization approaches may be implemented. As a non-limiting example, with respect to vectorization of documents, a document vectorization approach that leverages a word vectorization technique is utilized. The word vectorization technique may be based on a continuous bag of words (CBOW), skip gram, or other technique that creates numerical representations of words while also encoding relational information between words (e.g., words that are frequently used together are numerically closer, as well). Document vectorization can be performed by generating a document vector that is based on how word vector representations are related at a document level (e.g., a paragraph level). Thus, word-level features and document-level features (e.g., in which paragraphs words are located) can both be represented. A distributed memory version of paragraph vector (PV-DM), distributed bag of words version of paragraph vector (PV-DBOW), or another technique that adds document-level information to word-level representations may be utilized for document vectorization. It is also possible to encode specific, semantically explanatory document-level information. For example, with respect to the sinus pause example, features such as publication year, scientific journal title, and so forth may be encoded. In various embodiments, a document vectorization model is first trained on numerous training examples before it is deployed for use by vector module 114. For example, with respect to the sinus pause example, the training examples may be various biomedical scientific articles.

In various embodiments, a collection of relevant content items is ultimately determined in response to the search specification. For example, with respect to the sinus pause example, a set of highly relevant scientific articles (that may or may not include the term “sinus pause”) may be determined. In some embodiments, analysis module 116 utilizes vector representations generated by vector module 114 to determine the collection of relevant content items. In various embodiments, as part of the determination of the collection of relevant content items, a centroid vector is calculated based on vector representations of content items. In some embodiments, in order to calculate the centroid vector, a relevant initial subset of content items is identified based on the search specification. In some embodiments, this relevant initial subset of content items is the set of content items from the corpus of content items that are keyword-based search matches (region 204 of FIG. 2). For example, with respect to the sinus pause example, this may include scientific articles in the established search space that explicitly mention sinus pause. The centroid vector for this example would be calculated based on the corresponding vector representations of these scientific articles that explicitly mention sinus pause. In some embodiments, the centroid vector is an average of the vector representations of the content items in the relevant initial subset of content items. With respect to the sinus pause example, this may include the average of the vector representations of the scientific articles that explicitly mention sinus pause. The average can be calculated on an element-by-element basis. Vectorization display element 304 shows an example of a centroid vector for the sinus pause example. Each element of the centroid vector in vectorization display element 304 may be an average of corresponding elements of vector representations of scientific articles, in the established search space, that explicitly mention sinus pause. This average may be a simple numerical average of each element of the vector representations to determine a new average vector. It is also possible to employ different types of averages or different types of vector aggregation methods to calculate the centroid vector (e.g., by summing the vector representations of the content items, using machine learning to train a model to calculate the best centroid vector to represent a subset of content items, etc.). As a non-limiting example, a weighted average is utilized. With respect to the sinus pause example, each document can be weighted according to a specified document property, such as the frequency of the search term “sinus pause” in each document. Various other weighting approaches can also be adopted. For example, each vector can be weighted or otherwise configured to induce a different impact on centroid calculation and eventual visualization. Accordingly, the vector and/or underlying document can be weighted, wherein a weight (e.g., a constant or dynamic value) corresponds to the frequency of the corresponding search term, the prominence of the clinical trial sponsor, the timestamp (i.e., newer clinical trials may be afforded a heftier weighting), the clinical trial phase, the primary indication (i.e., whether the search keyword is a primary versus secondary indication), and other suitable metrics. Therefore, the centroid may be “pulled closer” to the more weighted vector(s) based on the aforementioned weighting factors. In various embodiments, a user is also able to interact with vectorization display element 304 to display vectors other than the centroid vector (e.g., by clicking on different items of visualization element 306).

In various embodiments, with the centroid vector calculated, analysis module 116 determines nearest neighbors of the centroid vector. Corresponding vector representations of content items in the corpus of content items can be analyzed to determine their distances (or other vector comparison metrics, such as cosine similarity) to the centroid vector. In some embodiments, a Euclidean distance is calculated from the centroid vector to each vector representation. The distance of a vector representation to the centroid vector may be a measure of a relative relevancy of the corresponding content item. The centroid vector can be considered a type of average (e.g., highly representative) representation of a relevant search result. Thus, the distance of another vector to the centroid vector can be interpreted as how close the content item for that other vector is to a representative average of highly relevant content items. Visualization element 306 shown in FIGS. 3A and 3B (FIG. 3B comprising a zoomed in, expanded view of a portion of FIG. 3A) plots vector representations for content items in a manner that depicts their distances from the centroid vector, with the interpretation being that the distances correspond to relative relevancies. In an embodiment, the content item relevancy can be calculated by a system receiving its vector representation and the centroid vector representation as inputs and outputting a relevancy score (e.g., using a trained machine learning or deep learning approach, handcrafted or fitted equation or any other method operating on vector representations to compute a relevancy score). In an embodiment, visualization module 118, shown in FIG. 1, utilizes the results of analysis module 116 to provide a visualization that can be viewed by a user (e.g., on client 102 via network 104). In various embodiments, visualization element 306 of FIGS. 3A and 3B is interactive and/or includes interactive elements. As a non-limiting example, a user is able to select (e.g., click) on an item (e.g., a circle as shown in visualization element 306) to view additional information about the item. This and other types of possible interactions are described in further detail herein.

Visualization element 306 of FIGS. 3A and 3B are accompanied by legend 308 in FIGS. 3A and 3B. As shown by legend 308 in FIG. 3B, for the example of sinus pause, the centroid point (corresponding to the centroid vector) is indicated by marker type 320, of which there is only one marker in visualization element 306 because one centroid is calculated and displayed in this specific example. However, it is also possible for a topic of interest such as sinus pause to have sub-categories that can each include their own centroids to aid with refining the identification of relevant documents. Excluded documents from the centroid calculation can also serve in the creation of a negative or not-relevant centroid to identify a vector space to be excluded. Thus, it is possible to calculate and display multiple centroid vectors for different vector space mappings (e.g., for both relevant and non-relevant vector space mappings). In various embodiments, the systems and methods described herein can comprise a multitude of centroid types, wherein said centroid types may be simultaneously implemented and/or displayed in visualization element 306. As non-limiting examples, centroids of varying weighting methods may be generated and displayed; “negative” centroids comprising undesired documents may be generated and displayed and/or may be represented as an absence in visualization element 306; and centroids may be directly user-defined, wherein a user may indicate articles or documents intended to be included or excluded. In the instance of a negative centroid, one or more of the neighbors to the negative centroid may be excluded. The top ten nearest neighbors to the centroid are indicated by two categories of marker types: marker types 322 and 324, with marker type 322 corresponding to content items with the keyword “sinus pause” (content items able to be surfaced via keyword-based search) and marker type 324 corresponding to content items without the keyword “sinus pause” (failure to match via keyword-based search, and instead, content items surfaced only via vector-based search). In effect, the first category of nearest neighbors may correspond to matches of a keyword-based search for the search specification and the second category of nearest neighbors may correspond to content items derived via a vector-based search. Thus, in various embodiments, content items indicated by marker type 322 are content items from the relevant initial subset of content items (described above) used to calculate the centroid vector and content items indicated by marker type 324 are other content items (not used to calculate the centroid vector). In the example shown, in visualization element 306, the top ten nearest neighbors are composed of three content items of marker type 322 and seven content items of marker type 324. The value ten is merely illustrative and not restrictive. The number of content items to display as nearest neighbors can be adjusted (e.g., by a user). The content items in visualization element 306 indicated by marker type 326 are content items not belonging to the specified number (ten, in this case) of nearest neighbors to the centroid, which are interpreted to be less relevant content items.

In some embodiments, interacting with an item in visualization element 306 generates and/or displays a summary of the item. For example, with respect to the sinus pause example in which at least some content items are scientific articles, article summary 332 is configured to appear when selecting the item of marker type 322 shown in visualization element 306 that points to article summary 332 and article summary 334 appears when selecting the item of marker type 324 shown in visualization element 306 that points to article summary 334. The article summaries 332/334 may include one or more highlights, graphical, or identifying features configured to bring attention to a particular aspect of the summary 332/334. For example, as shown in FIG. 3B, the keyword “sinus pause” is boxed in article summary 332. However, as shown in FIG. 3B, the keyword “sinus pause” does not appear in article summary 334. Yet, a related term “tachycardia” appears in article summary 334 and is boxed. Tachycardia is an adverse event in a similar domain as sinus pause. Thus, article summary 334 is relevant to the centroid for sinus pause (just as article summary 332 is) because tachycardia is relevant to sinus pause. Article summary 334 illustrates an example of content that would not have been surfaced based on keyword-based search alone, and thus illustrates a technological benefit of the techniques disclosed herein. Clusters of similar content items, including content items that do not include specific search keywords, can be discovered more efficiently, leading to increased user productivity.

In some embodiments, a user can interact with the centroid in visualization element 306 (e.g., by clicking and selecting an option from a menu) to generate and display a semantic interpretation word cloud associated with the centroid. Display element 310 of FIG. 3A shows a word cloud for the sinus pause example. Display element 310 shows various semantic concepts related to sinus pause. In various embodiments, the semantic concepts shown in the word cloud are derived based on the nearest neighbors of the centroid. This allows the user to access a preview of semantic concepts associated with the centroid before investigating specific nearest neighbors of the centroid, which allows the user to quickly gain a summary of the content associated with the centroid. In various embodiments, the user is able to update the centroid by selecting another item in visualization element 306. Upon selection of another centroid, a new set of nearest neighbors is computed and displayed, and a new word cloud can be generated and displayed, as well. In various embodiments, the user can select a different cluster, which may be comprised of more or fewer content items, to serve as the word cloud. In various embodiments, the semantic concepts displayed in the word cloud are based on the most common words and/or words most widely used across documents used to generate the word cloud. Various additional processing may also be utilized. For example, filtering based on a term frequency-inverse document frequency (TF-IDF) statistic or other statistic may be employed to exclude very common words that are not conceptually impactful.

In various embodiments, the user can interact with visualization element 306 in various ways. For example, the user can select any item (any circle shown in visualization element 306) to view a content item summary (e.g., an article summary with respect to the sinus pause example) and/or word cloud to determine whether to use the content item as a centroid and cluster around that content item. When used in this manner, the centroid can correspond to a specific content item. In general, the centroid is a point in vector space that does not necessarily correspond to any specific content item (e.g., when the centroid is generated automatically based on a relevant initial subset of content items as described above). Thus, in such an embodiment, the user is able to search for information interactively and iteratively by selecting a content item to be the centroid, evaluating the nearest neighbors, perhaps selecting one of these nearest neighbors (or some other content item) to be a new centroid, evaluating the nearest neighbors of the selected nearest neighbor, and so forth. In some embodiments, the system is configured to allow the user to exclude specific content items and add others when recalculating the centroid, or manually weight different content items (e.g., according to how close those content items are to specified points in the displayed vector space, such as closeness to previously calculated centroids) to indicate which ones are more important and then recalculate. In various embodiments, the user can interact with the centroid (e.g., by clicking on the centroid vector) to highlight all content items used in its calculation. Viewing all content items can assist the user identify clusters of content items that are isolated or far away from the centroid, which can facilitate the user's selection of content items to exclude to refine the centroid vector. It is also possible for the user to provide an entire set of content items (e.g., ten documents with respect to the sinus pause example) to average to compute the centroid. In some embodiments, this option is also available to calculate an initial centroid instead of calculating the initial centroid automatically based on keyword-based search matches, which allows for a centroid tailored to what the user believes is a more representative average, instead of a global average. The centroid calculation can be optimized to yield better vector-based searches. For example, one way to optimize is to select a subset deemed highly relevant instead of utilizing all content items found with the keyword-based search. This results in moving the centroid vector closer to a more relevant content item space.

In visualization element 306, in an embodiment, the distance from an item (a circle as shown in visualization element 306) to the centroid has the interpretation of relevance of the corresponding content item to the centroid, which represents either a specific content item or an average of content items. In various embodiments, the distance (relative spacing) between any two points (any two circles) in visualization element 306 has the interpretation of relatedness (closeness) of their corresponding content items. In one embodiment, the relative spacing between points/circles in visualization element 306 may be a function of the mapped relative relevancies between said points/circles or the underlying item thereof. In another embodiment, the relative spacing between points/circles in visualization element 306 may be a function of the distances calculated between the vector representations. Although, each item and/or point in visualization element 306 may represent a point in an N-dimensional vector space (each vector representation being N-dimensional), a two-dimensional display as illustrated in visualization element 306 is possible via a dimensionality reduction technique. As a non-limiting example, in some embodiments, principal component analysis (PCA) is utilized to plot vector representations in two dimensions (with the axes corresponding to the two principal components determined). As used herein, PCA refers to any of the various vector projection techniques known by those skilled in the art to compute principal components of vector data and use them to perform a change of basis on the data, retaining only a specified number of principal components and ignoring the rest. The example shown is merely illustrative and not restrictive. For example, it is also possible to retain three principal components and display a three-dimensional visualization, wherein the three-dimensional distance between any two points corresponds to relatedness of their corresponding content items. It is also possible to visualize four-dimensional data (e.g., using a series of three-dimensional displays or using colors or circle sizes to represent a fourth dimension). In some embodiments, the user is also able to view a list representation of the data in visualization element 306. For example, the list may show content items in order from most related to the centroid to least related (corresponding to points of closest distance to the centroid shown first in the list). The list can be filtered in various ways in order to aid interpretation for the user. For example, the list may be filtered based on which content items match the keyword search and which ones do not.

Returning to FIG. 1, portions of the communication path between the components are shown. Other communication paths may exist, and the example of FIG. 1 has been simplified to illustrate the example clearly. Although single instances of components have been shown to simplify the diagram, additional instances of any of the components shown in FIG. 1 may exist. For example, additional clients may exist. The number of components and the connections shown in FIG. 1 are merely illustrative. Components not shown in FIG. 1 may also exist.

FIG. 2 is a diagram illustrating an intersection of keyword-based search and vector-based search results. FIG. 2 is described in further detail above with respect to FIG. 1.

FIG. 3A is a diagram illustrating user interface elements of a system for determining and displaying related content items based on their vector representations. FIG. 3A is described in further detail above with respect to FIG. 1.

FIG. 3B is a diagram illustrating in detail a visualization of related content items. FIG. 3B is described in further detail above with respect to FIG. 1.

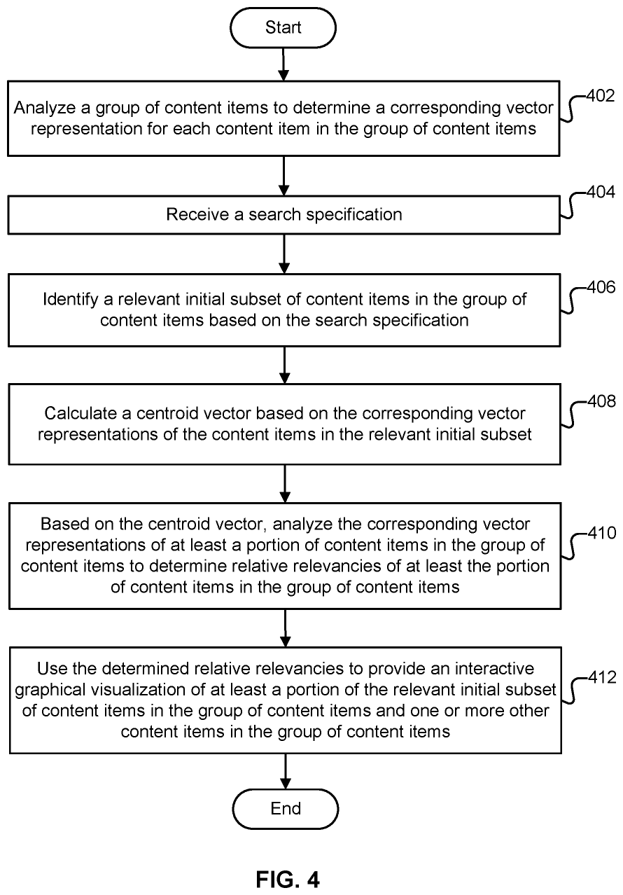

FIG. 4 is a flow diagram illustrating an embodiment of a process for determining and displaying related content items based on their vector representations. In some embodiments, the process of FIG. 4 is performed by service 110, as shown in FIG. 1.

At 402, a group of content items may be analyzed to determine a corresponding vector representation for each content item in the group of content items. In various embodiments, the corresponding vector representation includes a set of identifiers representing the corresponding content item in the group of content items. In some embodiments, the group of content items is a subset of an online source of content items (e.g., content database 106 of FIG. 1). For example, with respect to the sinus pause example, the group of content items may be a subset of PubMed® articles (e.g., those relating to autoimmune diseases) or portions thereof (e.g., abstracts of the articles). Accordingly, the group of content items may be a subset of content items from another source. In some embodiments, vector module 114 of FIG. 1 determines the corresponding vector representation for each content item in the group of content items. In various embodiments, the set of identifiers is an array of numerical values. For example, each of the set of identifiers may be appended, or otherwise correlated, to each of the vector representations, such that each of the vector representations may be tracked to the corresponding content item. Thus, in effect, the identifiers may act as tags applied to each of the vector representations to maintain understanding of the content and/or source that each vector representation relates to. In one embodiment, 402 may be executed by the server 108 and/or a server processor thereof. Alternatively, the 402 may be executed by the client device 102.

At 404, a search specification may be received. In some embodiments, the search specification is received by search module 112 of FIG. 1. In various embodiments, the search specification includes a search keyword (e.g., sinus pause). Search element 302 of FIG. 3A is an example of a user interface component for receiving the search specification. As a non-limiting example, the search specification may include a search keyword (e.g., sinus pause) and one or more additional parameters (e.g., timestamps, preferred sections of documents [i.e., title, abstract, etc.], particular treatments, etc.). Such additional parameters may be selected by a user, for example, via the user interface component. The one or more additional parameters may be selectable via dropdown menus, sliders, text entry fields, or other suitable means.

At 406, a relevant initial subset of content items in the group of content items may be identified based on the search specification. In some embodiments, analysis module 116 of FIG. 1 performs the identification. In some embodiments, the relevant initial subset of content items is the subset of content items that explicitly match the search specification. For example, with respect to the sinus pause example, this would be the articles in the search space that explicitly mention the search keyword “sinus pause”.

At 408, a centroid vector may be calculated based on the corresponding vector representations of the content items in the relevant initial subset. In some embodiments, the centroid vector is calculated by analysis module 116 of FIG. 1. As a non-limiting example, the server 110 may comprise one or more server processors, wherein the one or more server processors are configured to execute one or more of the steps described herein. In various embodiments, the centroid vector is calculated as the average vector of the corresponding vector representations of the content items in the relevant initial subset. The centroid vector itself may not necessarily have a corresponding content item, but rather may be a point in vector space around which vector representations of content items relevant to the search specification can be clustered.

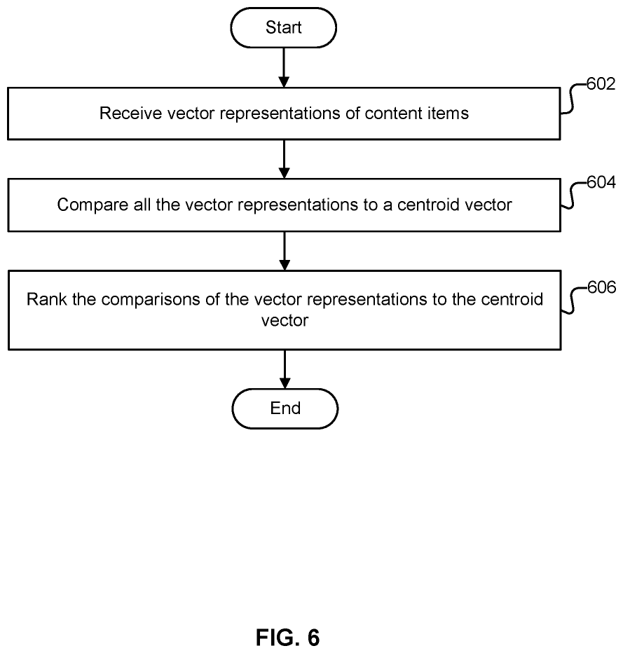

At 410, based on the centroid vector, the corresponding vector representations of at least a portion of content items in the group of content items may be analyzed to determine relative relevancies of at least the portion of content items in the group of content items. In some embodiments, this analysis is performed by analysis module 116 of FIG. 1. In some embodiments, the analysis includes determining a distance metric between the centroid vector and each corresponding vector representation of the vector representations of at least the portion of content items in the group of content items. An example of a distance metric is Euclidean distance, which can be utilized to determine a distance between two vectors. The corresponding content items of the vector representations that are closest in distance to the centroid vector can be interpreted to be the most relevant content items relative to an average, representative content item represented by the centroid vector. FIG. 6 and the accompanying description below provide further details regarding the process for determining relative relevancies of content items.

At 412, the determined relative relevancies may be used to provide an interactive graphical visualization of at least a portion or segment of the relevant initial subset of content items in the group of content items and one or more other content items in the group of content items. Thus, in effect, the interactive graphical visualization may include: (1) a portion or segment of the relevant initial subset of content items in the group of content items, e.g., content items unearthed via a keyword-based search; (2) one or more other content items in the group of content items, e.g., content items unearthed via vector-based analysis; or (3) a combination of (1) and (2). The “portion” or “segment” of the relevant initial subset of content items may refer to a subset of content items constrained by a parameter, e.g., the preferred number of keyword-based search results to be populated on the interactive graphical visualization, a secondary filter further constricting results in addition to the search specification, or other suitable parameters. In some embodiments, visualization module 118 provides the interactive graphical visualization to client 102 via network 104. In some embodiments, a specified number of most relevant content items (e.g., ten in the sinus pause example) are visually highlighted and/or identified in the interactive graphical visualization. For example, in visualization element 306, the ten nearest neighbors to the centroid are visually distinguished using special marker types. In various embodiments, and as illustrated in visualization element 306, the visualized content items include content items from the relevant initial subset of content items utilized to calculate the centroid vector as determined by a keyword-based search. In various embodiments, the one or more other content items include content items that would not have been determined using the keyword-based search. In various embodiments, these one or more other content items are determined using the vector-based comparisons at 410. In an embodiment, the server 110 and/or the visualization module 118 may generate the graphical visualization, such that said graphical visualization may be provided to, and displayed on, the client device 102. In an alternate embodiment, the graphical visualization may include at least a segment of the relevant initial subset (i.e., in instances where the nearest neighbors are vectors correlated to the specification/keyword search) and/or corresponding vector representations with sufficient relative relevancies. Thus, for example, in various instances, the graphical visualization may include: (1) a mixture of “keyword” based results and “centroid” based results; (2) all “keyword based results; or (3) all “centroid” based results. In a preferred instance, the graphical representation includes a mixture of both “keyword” and “centroid” based results.

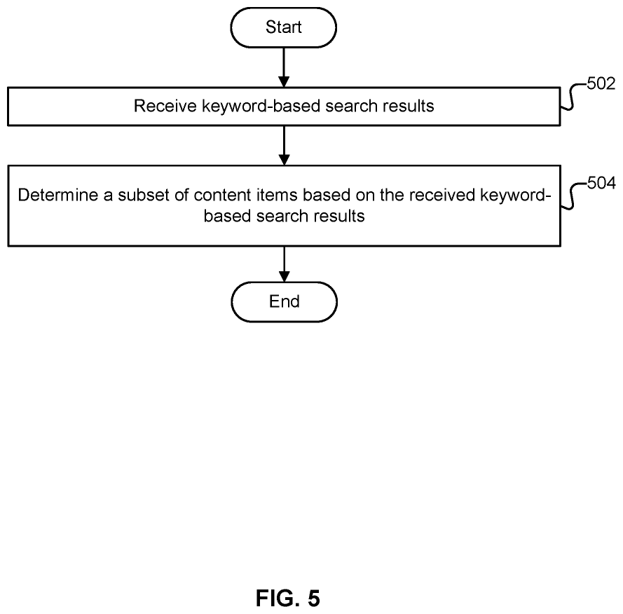

FIG. 5 is a flow diagram illustrating an embodiment of a process for identifying a relevant initial subset of content items. In some embodiments, at least a portion of the process of FIG. 5 may be performed in 406 of FIG. 4.

At 502, keyword-based search results may be received. In various embodiments, the keyword-based search results are based on a user-inputted keyword or term. Sinus pause is an example of such a keyword/term with respect to a biomedical context. Various search techniques for performing keyword-based search known to those skilled in the art may be employed. As a non-limiting example, the search may involve crawling an index. In various embodiments, a match requires the search keyword/term or an associated word root (e.g., a plural version of a singular keyword/term) to be present in a content item. Content items that are matches may be stored in a list of matching content items.

At 504, a subset of content items may be determined based on the received keyword-based search results. In various embodiments, the relevant initial subset of content items is determined to be all content items that are matches for the keyword/term. It is also possible that additional filtering is required. For example, if the keyword-based search results are not limited to a domain area of interest, then filtering based on domain area may be employed. For example, with respect to the example of sinus pause, it may be desirable to limit results to autoimmune diseases domains. Thus, results outside of these domains may be excluded if such exclusion was not already performed at the keyword-based search stage.

FIG. 6 is a flow diagram illustrating an embodiment of a process for determining relative relevancies of content items. In some embodiments, at least a portion of the process of FIG. 6 may be performed in 410 of FIG. 4.

At 602, vector representations of content items are received. In various embodiments, all the vector representations are the same size. Stated alternatively, the vector representations may all occupy the same vector space in terms of dimensionality.

At 604, all the vector representations may be compared to a centroid vector. In an embodiment, the centroid vector is of the same dimensionality as the vector representations of the content items to allow for direct comparison. In various embodiments, the comparison comprises computing a vector distance between each vector representation and the centroid vector. In some embodiments, the vector distance is a Euclidean distance given by the formula: d(v,c)=\sqrt{(v₁−c₁)²+(v₂−c₂)²+ . . . +(v_{N}−c_{N})²}, where v is a vector to be compared to the centroid vector and c is the centroid vector. In this formula, both v and c have N vector components, and d is the determined distance between v and c. The comparison to the centroid vector may result in a relevancy score, which, in general, is not limited to a score associated with distance calculation. Moreover, various other vector comparison metrics (e.g., cosine similarity or another metric) can be utilized.

At 606, the comparisons of the vector representations to the centroid vector may be ranked. In various embodiments, the comparisons are ranked in order of smallest to largest distance d(v,c) for the various vectors compared to the centroid vector. In various embodiments, a content item whose vector representation is a smaller distance to the centroid vector is interpreted to be more relevant than another content item whose vector representation is a larger distance from the centroid vector.

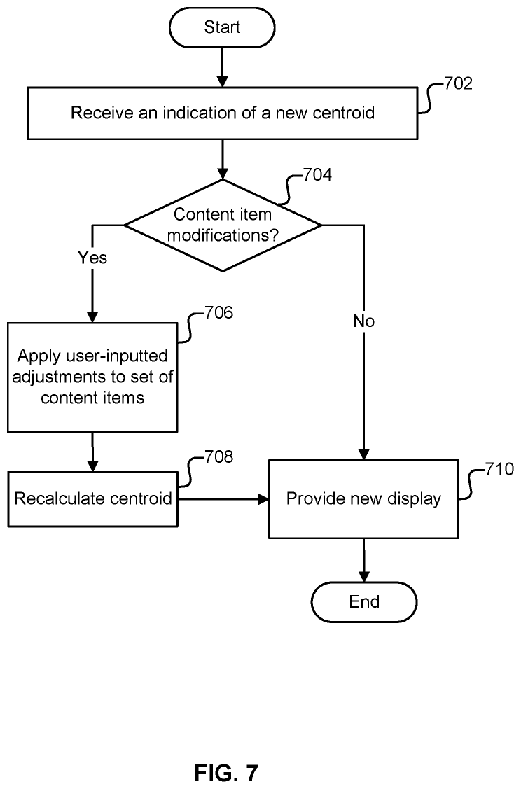

FIG. 7 is a flow diagram illustrating an embodiment of a process for modifying a centroid. In some embodiments, the process of FIG. 7 is performed by service 110 with input from client 102. The flow diagram shown in FIG. 7 is illustrative and not restrictive. Various other flows for modifying the centroid are also possible.

At 702, an indication of a new centroid may be received. In some embodiments, a user indicates that a new centroid is desired by interacting with visualization element 306. For example, the user may select a nearest neighbor of the current centroid or any other point displayed to be the new centroid.

At 704, it may be determined whether there are any modifications to the set of content items utilized to calculate the current centroid. In various embodiments, this is indicated by the user (e.g., by selecting an option from a menu). For example, the user can choose to add or exclude one or more content items from the centroid calculation. The user may also completely specify which content items are to be used to calculate the new centroid or specify weights for different content items in the new centroid calculation. If it is determined that such modifications exist, at 706, these user-inputted adjustments may be applied to the set of content items used for centroid calculation (adding, excluding, and weighting content items as appropriate). After these adjustments, at 708, the new centroid may be recalculated. In some embodiments, the new centroid is calculated as the average vector of the (potentially weighted) vector representations corresponding to the content items selected to be included in the new centroid calculation. At 710, a new display of the new centroid and other content items is provided. As a non-limiting example, the new centroid is highlighted and new nearest neighbors are computed and displayed. In such a non-limiting example, the display may also be adjusted to reflect the addition and/or exclusion of content items previously displayed.

If it is determined at 704 that no modification of content items is required, at 710, a new display may be provided in which the new centroid is displayed and new nearest neighbors are computed and displayed. In such an embodiment, the new centroid may not necessitate recalculation if the set of content items in the display has not changed (no additions, exclusions, or changed weightings of content items).

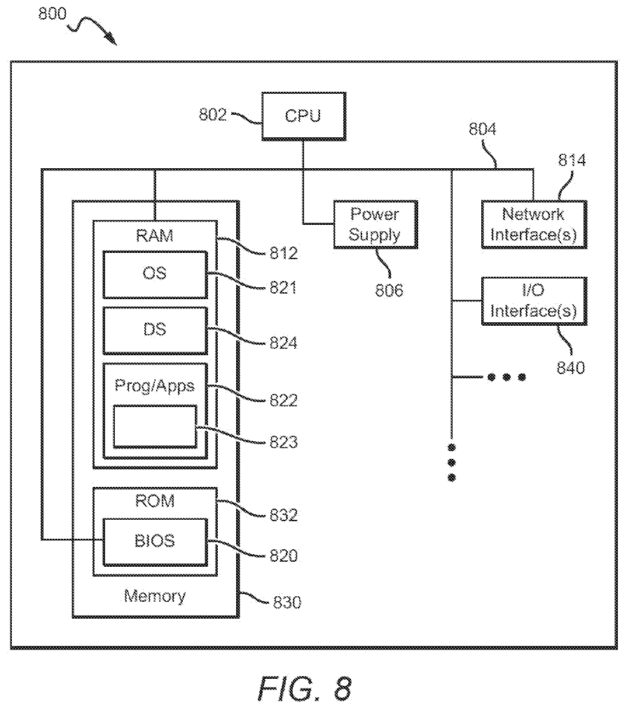

FIG. 8 is a functional diagram illustrating a programmed computer system. In some embodiments, the processes of FIGS. 4-7 are executed by computer system 800. In some embodiments, service 110 of FIG. 1 is embodied in computer program instructions that are executed by computer system 800.

In the example shown, computer system 800 includes various subsystems as described below. Computer system 800 includes at least one microprocessor subsystem (also referred to as a processor or a central processing unit (CPU)) 802. Computer system 800 can be physical or virtual (e.g., a virtual machine). For example, processor 802 can be implemented by a single-chip processor or by multiple processors. In some embodiments, processor 802 is a general-purpose digital processor that controls the operation of computer system 800. Using instructions retrieved from memory 830, processor 802 controls the reception and manipulation of input data, and the output and display of data on output devices.

Processor 802 is coupled bi-directionally with memory 830, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also, as is well known in the art, primary storage typically includes basic operating instructions, program code, data, and objects used by processor 802 to perform its functions (e.g., programmed instructions). For example, memory 830 can include any suitable computer-readable storage media, described below, depending on whether, for example, data access needs to be bi-directional or uni-directional. For example, processor 802 can also directly and very rapidly retrieve and store frequently needed data in a cache memory (not shown).

Network interface 814 allows processor 802 to be coupled to another computer, computer network, or telecommunications network using a network connection as shown. For example, through network interface 814, processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect computer system 800 to an external network and transfer data according to standard protocols. Processes can be executed on processor 802, or can be performed across a network such as the Internet, intranet networks, or local area networks, in conjunction with a remote processor that shares a portion of the processing. Additional mass storage devices (not shown) can also be connected to processor 802 through network interface 814.

An auxiliary I/O device interface (not shown) can be used in conjunction with computer system 800. The auxiliary I/O device interface can include general and customized interfaces that allow processor 802 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 8 is but an example of a computer system suitable for use with the various embodiments disclosed herein. Other computer systems suitable for such use can include additional or fewer subsystems. In addition, bus is illustrative of any interconnection scheme serving to link the subsystems. Other computer architectures having different configurations of subsystems can also be utilized.

FIG. 8 illustrates a block diagram of an electronic device 800 that can implement one or more aspects of an apparatus, system and method for validating and correcting user information (the “Engine”) according to one embodiment of the invention. Instances of the electronic device 200 may include servers, e.g., servers 108, and client devices, e.g., client devices 102. In general, the electronic device 800 can include a processor/CPU 802, memory 830, a power supply 806, and input/output (I/O) components/devices 840, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 800. A touchscreen may determine whether a user is providing input by, for example, determining whether the user is touching the touchscreen with a part of the user's body such as his or her fingers. The electronic device 800 can also include a communications bus 804 that connects the aforementioned elements of the electronic device 800. Network interfaces 814 can include a receiver and a transmitter (or transceiver), and one or more antennas for wireless communications.

The processor 802 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 830, which can include Random Access Memory (RAM) 812 and Read Only Memory (ROM) 832, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 821, data storage 824, which may include one or more databases, and programs and/or applications 822, which can include, for example, software aspects of the program 823. The ROM 832 can also include Basic Input/Output System (BIOS) 820 of the electronic device.

Persistent memory (e.g., a removable mass storage device) provides additional data storage capacity for computer system 800, and is coupled either bi-directionally (read/write) or uni-directionally (read only) to processor 802. For example, persistent memory can also include computer-readable media such as magnetic tape, flash memory, PC-CARDS, portable mass storage devices, holographic storage devices, and other storage devices. A fixed mass storage can also, for example, provide additional data storage capacity. The most common example of fixed mass storage 820 is a hard disk drive. Persistent memory and fixed mass storage generally store additional programming instructions, data, and the like that typically are not in active use by the processor 802. It will be appreciated that the information retained within persistent memory and fixed mass storage can be incorporated, if needed, in standard fashion as part of memory (e.g., RAM) as virtual memory.

In addition to providing processor 802 access to storage subsystems, bus can also be used to provide access to other subsystems and devices. As shown, these can include a display monitor, a network interface 814, a keyboard, and a pointing device, as well as an auxiliary input/output device interface, a sound card, speakers, and other subsystems as needed. For example, pointing device can be a mouse, stylus, track ball, or tablet, and is useful for interacting with a graphical user interface.

Software aspects of the program 823 are intended to broadly include or represent all programming, applications, algorithms, models, software and other tools necessary to implement or facilitate methods and systems according to embodiments of the invention. The elements may exist on a single computer or be distributed among multiple computers, servers, devices or entities.

The power supply 806 contains one or more power components, and facilitates supply and management of power to the electronic device 800.

The input/output components, including Input/Output (I/O) interfaces 840, can include, for example, any interfaces for facilitating communication between any components of the electronic device 800, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 840 and the bus 804 can facilitate communication between components of the electronic device 800, and in an example can ease processing performed by the processor 802.

Where the electronic device 800 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as network 104, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 104, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G), and 5th (5G) generation, Long Term Evolution (LTE) radio access for cellular systems, WLAN, Wireless Router (WR) mesh, and the like. Access technologies such as 2G, 2.5G, 3G, 4G, 5G and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present invention include apparatuses, systems, and methods implementing the Engine. Embodiments of the present invention may be implemented on one or more of client devices 102, which are communicatively coupled to servers including servers 108. Moreover, client devices 102 may be communicatively (wirelessly or wired) coupled to one another. In particular, software aspects of the Engine may be implemented in the program 223. The program 823 may be implemented on one or more client devices 102, one or more servers 108 or a combination of one or more client devices 102 and one or more servers 108.

In an embodiment, the system may receive, process, generate and/or store time series data. The system may include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data.

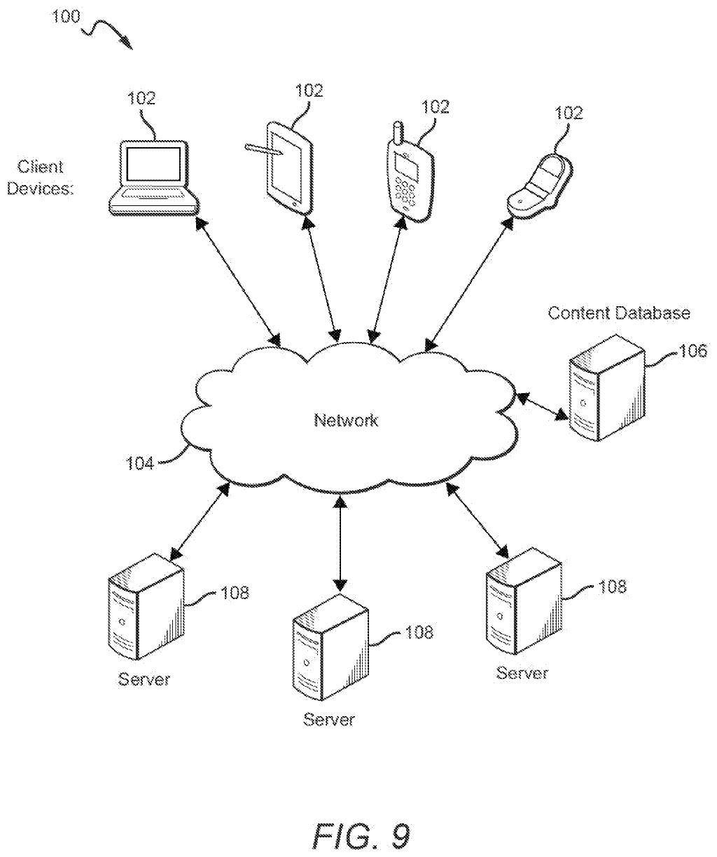

FIG. 9 illustrates components of one embodiment of an environment in which the invention may be practiced. Not all of the components may be required to practice the invention, and variations in the arrangement and type of the components may be made without departing from the spirit or scope of the invention. As shown, the system 100 includes one or more Local Area Networks (“LANs”)/Wide Area Networks (“WANs”) 104, one or more wireless networks 104, one or more wired or wireless client devices 106, mobile or other wireless client devices 102, servers 108, and may include or communicate with one or more data stores or databases. Various of the client devices 102 may include, for example, desktop computers, laptop computers, set top boxes, tablets, cell phones, smart phones, smart speakers, wearable devices (such as the Apple Watch) and the like. Servers 108 can include, for example, one or more application servers, content servers, search servers, and the like. FIG. 9 also illustrates content database 106.

Illustrative examples of the technologies disclosed herein are provided below. An embodiment of the technologies may include any one or more, and any combination of, the examples described below.

Example 1 includes a method, the method comprising: analyzing a group of content items to determine a corresponding vector representation for each content item in the group of content items, wherein the corresponding vector representation includes a set of identifiers representing the corresponding content item in the group of content items; receiving a search specification; identifying a relevant initial subset of content items in the group of content items based on the search specification; using one or more processors to calculate a centroid vector based on the corresponding vector representations of the content items in the relevant initial subset; based on the centroid vector, analyzing the corresponding vector representations of at least a portion of content items in the group of content items to determine relative relevancies of at least the portion of content items in the group of content items; and using the determined relative relevancies to provide an interactive graphical visualization of at least a portion of the relevant initial subset of content items in the group of content items and one or more other content items in the group of content items.

Example 2 includes the subject matter of Example 1, and wherein the search specification includes text entered by a user or an item selected by the user from a taxonomy of topics.

Example 3 includes the subject matter of any of Examples 1 and 2, and wherein the group of content items is a subset of content items from another source of content items.

Example 4 includes the subject matter of any of Examples 1-3, and wherein identifying the relevant initial subset of content items in the group of content items based on the search specification includes automatically performing a keyword-based search to determine content items that match the keyword-based search.

Example 5 includes the subject matter of any of Examples 1-4, and wherein identifying the relevant initial subset of content items in the group of content items based on the search specification includes receiving from a user a collection of content items related to the search specification to serve as the relevant initial subset of content items.

Example 6 includes the subject matter of any of Examples I-5, and wherein calculating the centroid vector based on the corresponding vector representations of the content items in the relevant initial subset includes determining a vector aggregation of the corresponding vector representations of the content items in the relevant initial subset.

Example 7 includes the subject matter of any of Examples 1-6, and wherein analyzing the corresponding vector representations of at least the portion of content items in the group of content items to determine relative relevancies of at least the portion of content items in the group of content items includes computing a vector comparison metric to the centroid vector.

Example 8 includes the subject matter of Example 7, and wherein the vector comparison metric is a distance metric.

Example 9 includes the subject matter of any of Examples 1-8, and wherein the one or more other content items in the group of content items include content items that do not match a keyword-based search associated with the search specification.

Example 10 includes the subject matter of any of Examples 1-9, and wherein the interactive graphical visualization includes a multidimensional visualization of at least the portion of the relevant initial subset of content items in the group of content items and the one or more other content items in the group of content items.

Example 11 includes the subject matter of any of Examples 1-10, and wherein the interactive graphical visualization includes display items that have relative spacings between one another that map to relative relevancies between content items that correspond to the display items.

Example 12 includes the subject matter of any of Examples 1-11, and wherein the interactive graphical visualization includes display items that have relative spacings between one another that are based on distances between vector representations that correspond to the display items.

Example 13 includes the subject matter of any of Examples 1-12, and wherein the interactive graphical visualization includes axes that correspond to retained components of a vector projection technique.

Example 14 includes the subject matter of any of Examples 1-13, and wherein the interactive graphical visualization includes an identification of the centroid vector and a specified number of nearest neighbors to the centroid vector.

Example 15 includes the subject matter of Example 14, and wherein the specified number of nearest neighbors include two categories of nearest neighbors that are visually distinguished from each other: a first category of nearest neighbors corresponding to matches of a keyword-based search for the search specification and a second category of nearest neighbors corresponding to failures to match the keyword-based search for the search specification.

Example 16 includes the subject matter of any of Examples 1-15, and wherein the interactive graphical visualization includes a display of multiple centroid vectors corresponding to different vector space mappings.

Example 17 includes the subject matter of any of Examples 1-16, and further comprising updating the interactive graphical visualization to display a new centroid that corresponds to a content item selected by a user.

Example 18 includes the subject matter of any of Examples 1-17, and further comprising receiving a user selection of a content item and providing summary information for the content item of the user selection.

Example 19 includes the subject matter of any of Examples 1-18, and further comprising receiving from a user a specification of a content item to include or exclude from the group of content items or to weight differently for centroid vector calculation.

Example 20 includes the subject matter of any of Examples 1-19, and further comprising receiving a user interaction associated with the centroid vector and providing a list of content items associated with calculating the centroid vector.

Example 21 includes a system comprising: one or more processors and a memory coupled to at least one of the one or more processors and configured to provide at least one of the one or more processors with instructions for performing the method of any of Examples 1-20.

Example 22 includes a computer program product embodied in a non-transitory computer readable medium and comprising computer instructions for performing the method of any of Examples 1-20.

In an aspect of this disclosure, a computer-implemented method, may comprise the steps of analyzing, via one or more server processors, a group of content items to determine a corresponding vector representation for each content item in the group of content items, the corresponding vector representation comprising a set of identifiers representing the corresponding content item in the group of content items; receiving, via a server, a search specification; and identifying, via the server, based on the search specification, a relevant initial subset of content items in the group of content items. In an embodiment, the computer-implemented method may further comprise the steps of calculating, via the one or more server processors, a centroid vector based on the corresponding vector representations of the content items in the relevant initial subset; analyzing, via the one or more server processors, based on the centroid vector, the corresponding vector representations of at least a portion of content items in the group of content items to determine relative relevancies of the at least the portion of content items in the group of content items; and providing, via a client device in informatic communication with the server, based on the determined relative relevancies, an interactive graphical visualization of at least a segment of the relevant initial subset of content items in the group of content items and one or more other content items in the group of content items.

In an embodiment, the search specification includes text entered by a user or an item selected by the user from a taxonomy of topics. The group of content items may be a subset of content items from another source of content items. The method may further comprise the step of identifying the relevant initial subset of content items in the group of content items based on the search specification further comprising automatically performing a keyword-based search to determine content items that match the keyword-based search.

In a further embodiment, the step of identifying the relevant initial subset of content items in the group of content items based on the search specification may further comprise receiving, from a user, a collection of content items related to the search specification to serve as the relevant initial subset of content items. The step of calculating the centroid vector based on the corresponding vector representations of the content items in the relevant initial subset may further comprise determining a vector aggregation of the corresponding vector representations of the content items in the relevant initial subset.

The step of analyzing the corresponding vector representations of at least the portion of content items in the group of content items to determine relative relevancies of at least the portion of content items in the group of content items may further comprise computing a vector comparison metric to the centroid vector, wherein the vector comparison metric is a distance metric. In an embodiment, the one or more other content items in the group of content items comprise content items that do not match a keyword-based search associated with the search specification. In a further embodiment, the interactive graphical visualization comprises a multidimensional visualization of at least the segment of the relevant initial subset of content items in the group of content items and the one or more other content items in the group of content items.

In an embodiment, the interactive graphical visualization comprises display items that include relative spacings between one another that map to the relative relevancies between content items that correspond to the display items. The interactive graphical visualization may comprise display items that include relative spacings between one another that may be based on distances between vector representations that correspond to the display items. In an embodiment, the interactive graphical visualization comprises axes that correspond to retained components of a vector projection technique.

The interactive graphical visualization may comprise an identification of the centroid vector and a specified number of nearest neighbors to the centroid vector, and wherein the specified number of nearest neighbors comprises two categories of nearest neighbors that are visually distinguished from each other, wherein a first category of nearest neighbors corresponds to matches of a keyword-based search for the search specification and a second category of nearest neighbors corresponds to content items derived via a vector-based search. In an embodiment, the interactive graphical visualization comprises a display of multiple centroid vectors corresponding to different vector space mappings.

The computer-implemented method may further comprise the step of updating the interactive graphical visualization to display a new centroid that corresponds to a content item selected by a user. Further, the computer-implemented method may further comprise the steps of receiving a user selection of a content item; and providing summary information for the content item of the user selection. The computer-implemented method may further comprise the step of receiving, from a user, a specification of a content item to include or exclude from the group of content items or to weight differently for centroid vector calculation. In an embodiment, the method may further comprise the steps of receiving a user interaction associated with the centroid vector; and providing a list of content items associated with calculating the centroid vector.

In an aspect of this disclosure, a system comprises a server in bidirectional communication with a client device, the server comprising at least one server processor, at least one server database, at least one server memory comprising computer-executable server instructions which, when executed by the at least one server processor, cause the server to analyze, via one or more server processors, a group of content items to determine a corresponding vector representation for each content item in the group of content items, the corresponding vector representation comprising a set of identifiers representing the corresponding content item in the group of content items. The computer-executable server instructions which, when executed by the at least one server processor, may further cause the server to receive, via a server, a search specification; identify, via the server, based on the search specification, a relevant initial subset of content items in the group of content items; and calculate, via the one or more server processors, a centroid vector based on the corresponding vector representations of the content items in the relevant initial subset. In yet a further embodiment, the computer-executable server instructions which, when executed by the at least one server processor, cause the server to analyze, via the one or more server processors, based on the centroid vector, the corresponding vector representations of at least a portion of content items in the group of content items to determine relative relevancies of the at least the portion of content items in the group of content items; and provide based on the determined relative relevancies, an interactive graphical visualization of at least a segment of the relevant initial subset of content items in the group of content items and one or more other content items in the group of content items. The system may further comprise a client device comprising at least one device processor, at least one display, at least one device memory comprising computer-executable device instructions which, when executed by the at least one device processor, may cause the client device to display the interactive graphical visualization.

In an aspect of this disclosure, a computer program product embodied in a non-transitory computer readable medium comprises computer instructions for analyzing, via one or more server processors, a group of content items to determine a corresponding vector representation for each content item in the group of content items, the corresponding vector representation comprising a set of identifiers representing the corresponding content item in the group of content items; receiving, via a server, a search specification; identifying, via the server, based on the search specification, a relevant initial subset of content items in the group of content items; calculating, via the one or more server processors, a centroid vector based on the corresponding vector representations of the content items in the relevant initial subset; analyzing, via the one or more server processors, based on the centroid vector, the corresponding vector representations of at least a portion of content items in the group of content items to determine relative relevancies of the at least the portion of content items in the group of content items; and providing, via a client device in informatic communication with the server, based on the determined relative relevancies, an interactive graphical visualization of at least a segment of the relevant initial subset of content items in the group of content items and one or more other content items in the group of content items.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A computer-implemented method, comprising the steps of:
analyzing, via a one or more server processors, a group of content items to determine a corresponding vector representation for each content item in the group of content items, the corresponding vector representation comprising a set of identifiers representing the corresponding content item in the group of content items;
receiving, via a server, a search specification;
identifying, via the server, based on the search specification, a relevant initial subset of content items in the group of content items;
calculating, via the one or more server processors, a centroid vector based on the corresponding vector representations of the content items in the relevant initial subset;
analyzing, via the one or more server processors, based on the centroid vector, the corresponding vector representations of at least a portion of content items in the group of content items to determine relative relevancies of the at least the portion of content items in the group of content items; and
providing, via a client device in informatic communication with the server, based on the determined relative relevancies, an interactive graphical visualization of one or more of the relevant initial subset of content items in the group of content items, of one or more other content items in the group of content items, or of a combination thereof.

2. A system, comprising:
a server in bidirectional communication with a client device, the server comprising at least one server processor, at least one server database, at least one server memory comprising computer-executable server instructions which, when executed by the at least one server processor, cause the server to:
analyze, via one or more server processors, a group of content items to determine a corresponding vector representation for each content item in the group of content items, the corresponding vector representation comprising a set of identifiers representing the corresponding content item in the group of content items;
receive, via a server, a search specification;
identify, via the server, based on the search specification, a relevant initial subset of content items in the group of content items;
calculate, via the one or more server processors, a centroid vector based on the corresponding vector representations of the content items in the relevant initial subset;
analyze, via the one or more server processors, based on the centroid vector, the corresponding vector representations of at least a portion of content items in the group of content items to determine relative relevancies of the at least the portion of content items in the group of content items; and
provide based on the determined relative relevancies, an interactive graphical visualization of one or more of the relevant initial subset of content items in the group of content items, of one or more other content items in the group of content items, or of a combination thereof; and
a client device comprising at least one device processor, at least one display, at least one device memory comprising computer-executable device instructions which, when executed by the at least one device processor, cause the client device to:
display the interactive graphical visualization.

3. The system of claim 2, wherein the search specification comprises text entered by a user or an item selected by the user from a taxonomy of topics.

4. The system of claim 2, wherein the group of content items is a subset of content items from another source of content items.

5. The system of claim 2, wherein the computer-executable server instructions which, when executed by the at least one server processor, cause the server to identify the relevant initial subset of content items in the group of content items based on the search specification further causes the server to automatically perform a keyword-based search to determine content items that match the keyword-based search.

6. The system of claim 2, wherein the computer-executable server instructions which, when executed by the at least one server processor, cause the server to identify the relevant initial subset of content items in the group of content items based on the search specification further causes the server to receive, from a user, a collection of content items related to the search specification to serve as the relevant initial subset of content items.

7. The system of claim 2, wherein the computer-executable server instructions which, when executed by the at least one server processor, cause the server to calculate the centroid vector based on the corresponding vector representations of the content items in the relevant initial subset further cause the server to determine a vector aggregation of the corresponding vector representations of the content items in the relevant initial subset.

8. The system of claim 2, wherein the computer-executable server instructions which, when executed by the at least one server processor, cause the server to analyze the corresponding vector representations of at least the portion of content items in the group of content items to determine relative relevancies of at least the portion of content items in the group of content items further cause the server to compute a vector comparison metric to the centroid vector, wherein the vector comparison metric is a distance metric.

9. The system of claim 2, wherein the one or more other content items in the group of content items comprise content items that do not match a keyword-based search associated with the search specification.

10. The system of claim 2, wherein the interactive graphical visualization comprises a multidimensional visualization of at least the segment of the relevant initial subset of content items in the group of content items and the one or more other content items in the group of content items.

11. The system of claim 2, wherein the interactive graphical visualization comprises display items that include relative spacings between one another that map to the relative relevancies between content items that correspond to the display items.

12. The system of claim 2, wherein the interactive graphical visualization comprises display items that include relative spacings between one another that are based on distances between vector representations that correspond to the display items.

13. The system of claim 2, wherein the interactive graphical visualization comprises axes that correspond to retained components of a vector projection technique.

14. The system of claim 2, wherein the interactive graphical visualization comprises an identification of the centroid vector and a specified number of nearest neighbors to the centroid vector, and wherein the specified number of nearest neighbors comprises two categories of nearest neighbors that are visually distinguished from each other, wherein a first category of nearest neighbors corresponds to matches of a keyword-based search for the search specification and a second category of nearest neighbors corresponds to content items derived via a vector-based search.

15. The system of claim 2, wherein the interactive graphical visualization comprises a display of multiple centroid vectors corresponding to different vector space mappings.

16. The system of claim 2, the computer-executable server instructions which, when executed by the at least one server processor, cause the server to update the interactive graphical visualization to display a new centroid that corresponds to a content item selected by a user.

17. The system of claim 2, the computer-executable server instructions which, when executed by the at least one server processor, cause the server to receive a user selection of a content item; and provide summary information for the content item of the user selection.

18. The system of claim 2, the computer-executable server instructions which, when executed by the at least one server processor, cause the server to receive, from a user, a specification of a content item to include or exclude from the group of content items or to weight differently for centroid vector calculation.

19. The system of claim 2, the computer-executable server instructions which, when executed by the at least one server processor, cause the server to receive a user interaction associated with the centroid vector; and provide a list of content items associated with calculating the centroid vector.

20. A non-transitory computer readable medium having a set of instructions stored thereon that, when executed by a processing device, cause the processing device to carry out an operation of clinical result aggregation, the operation comprising:
analyzing, via one or more server processors, a group of content items to determine a corresponding vector representation for each content item in the group of content items, the corresponding vector representation comprising a set of identifiers representing the corresponding content item in the group of content items;
receiving, via a server, a search specification;
identifying, via the server, based on the search specification, a relevant initial subset of content items in the group of content items;
calculating, via the one or more server processors, a centroid vector based on the corresponding vector representations of the content items in the relevant initial subset;
analyzing, via the one or more server processors, based on the centroid vector, the corresponding vector representations of at least a portion of content items in the group of content items to determine relative relevancies of the at least the portion of content items in the group of content items; and
providing, via a client device in informatic communication with the server, based on the determined relative relevancies, an interactive graphical visualization of one or more of the relevant initial subset of content items in the group of content items, of one or more other content items in the group of content items, or of a combination thereof.

21. A computer-implemented method, comprising the steps of:
analyzing, via one or more server processors, a group of content items to determine a corresponding vector representation for each content item in the group of content items;
receiving, via a server, a search specification;
identifying, via the server, a relevant initial subset of content items in the group of content items;
calculating, via the one or more server processors, a centroid vector based on the corresponding vector representations of the content items in the relevant initial subset;
analyzing, via the one or more server processors, the corresponding vector representations of at least a portion of content items in the group of content items to determine relative relevancies of the at least the portion of content items in the group of content items; and
providing, based on the determined relative relevancies, an interactive graphical visualization of one or more of the relevant initial subset of content items in the group of content items, of one or more other content items in the group of content items, or of a combination thereof.
